(19) United States
(12) Patent Application Publication
(10) Pub. No.: US 2002/0146133 A1
(43) Pub. Date: Oct. 10, 2002

(54) Portable multimedia reproducing apparatus

(76) Inventors: Kyu Ho Lee, Seoul (KR); Yong Churl Kim, Daejon (KR)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/113,791

(22) Filed: Apr. 1, 2002

(30) Foreign Application Priority Data
Mar. 31, 2001 (KR) 2001-17101
Mar. 29, 2002 (KR) 2002-17210

(51) Int. Cl. H04R 5/00

(52) U.S. Cl. 381/1

(57) ABSTRACT

The invention is a card-like portable multimedia reproducing apparatus, which is small, light compact, and is capable of allowing digital compressed multimedia data pre-stored in a memory incorporated therein to be converted into a standard analog signal during reproductions thereby discouraging unauthorized copying of copyrighted materials. The apparatus comprises an input/output terminal, a memory for previously storing digital multimedia data, an operating portions a decoder for decoding the digital multimedia data, a converter for converting the decoded digital data into a standard analog signal, an MCU for controlling the memory, the decoder and the converter, responsive to an instruction from a user; a rechargeable battery for supplying a driving voltage to each element, and interfaces connected with the input/output terminal, for connecting the reproducing apparatus to a personal computer.

### FIELD OF THE INVENTION

The present invention relates to a multimedia reproducing apparatus; and, particularly, to a card type of portable multimedia reproducing apparatus for allowing stored compressed multimedia data to be converted into standard analog data during reproduction, thereby discouraging unauthorized copying of copyrighted materials.

### BACKGROUND OF THE INVENTION

There is a growing tendency for people to want to listen to music conveniently and inexpensively on portable audio devices, regardless of time and place. The advancement of hardware and software technologies related to the semiconductor industry has allowed small-sized, lightweight and multi-function audio devices.

As is well known, digital data can be copied many time over without loss of quality, but analog data cannot be copied repeatedly and retain quality over numerous copies. Data copying techniques are a by-product of data encoding/decoding schemes for various formats of audio and video data. It is feared that this will have an adverse effect on copyright protection. In addition, in a typical player using a media such as a CDROM, digital data stored in the media may be extracted as is, which allows a data copy or a spread of the copied data over another player, thereby making copyright infringement easy.

Thus, tho music and multi-media industries need a new data-reproducing device, which not only meets the demands of music buyers but also addresses copyright protection

### SUMMARY OF THE INVENTION

It is, therefore, an object of the present invention to provide a portable multimedia reproducing apparatus, which is small light, compact, and is capable of allowing digital compressed multimedia data pro-stored in a memory incorporated therein to be converted into a standard analog signal during reproduction, thereby discouraging unauthorized copying of copyrighted materials.

It is another object of the present invention to provide a portable multimedia reproducing apparatus, which is capable of downloading various multimedia data from a network to a memory in a portable multimedia reproducing apparatus which is small, light, compact, and capable of reproduction with external interfaces detachably coupled thereto.

In accordance with one aspect of the present invention, there is provided a portable multimedia reproducing apparatus, which comprises an input/output terminal, a memory in which the compressed digital multimedia data is previously stored, an operating portion having a plurality of buttons, a decoding means for decoding the compressed digital multimedia data, a converting means for converting the decoded digital multimedia data by the decoding means into a standard analog signal and outputting it through the input/output terminal, and a controlling means for controlling the memory, the decoding means and the converting means, responsive to an instruction from the operating portion by a user; and a power supply for supplying a driving voltage to each of the memory, the decoding means and tho converting means.

In accordance with another aspect of the present invention, there is provided a data reproducing apparatus, which comprises an input/output terminal, a memory in which the compressed digital multimedia data is previously stored, an operating portion, having a plurality of buttons, a decoding means for decoding the compressed digital multimedia data, a converting means for converting the decoded digital multimedia data by the decoding means to a standard analog signal and outputting it through the input/output terminal, a controlling means for controlling the memory, the decoding means and the converting means, responsive to an instruction from the operating portion by a user, a power supply for supplying a driving voltage to each of the memory, the decoding means and the converting means, and an interface connected with the input/output terminal, for connecting the reproducing apparatus to a personal computer.

### BRIEF DESCRIPTION OF THE DRAWINGS

The above and other objects and features of the present invention will become apparent from the following description of preferred embodiments given in connection with the accompanying drawings.

FIG. 1 shows a schematic block diagram of a card type of portable multimedia reproducing apparatus in accordance with a preferred embodiment of the present invention.

FIG. 2 schematically presents an internal, configuration of the memory shown in FIG. 1.

FIG. 3 illustrates header information corresponding to each memory block of the memory shown in FIG. 2.

FIG. 4 shows a schematic block diagram illustrating a data processing procedure for the portable multimedia reproducing apparatus inserted into an external audio system.

FIG. 5 illustrates data communications between the MCU of tie portable multimedia reproducing apparatus and an MCU of the external audio system.

FIG. 6 is a schematic block diagram of a portable multimedia reproducing apparatus showing another embodiment of the present invention.

FIG. 7 is a schematic block diagram of a portable multimedia reproducing apparatus in accordance with a further embodiment of the present invention.

FIG. 8 exemplifies a schematic block diagram of a portable multimedia reproducing apparatus in accordance with a further embodiment of the present invention.

FIG. 9 is a schematic block diagram of a portable multimedia reproducing apparatus in accordance with another preferred embodiment of the present invention.

FIG. 10 illustrates the portable multimedia reproducing apparatus in FIG. 9 downloading digital multimedia data on communication networks using external interfaces and a personal computer.

FIG. 11 is a diagram illustrating an audio file download to the portable, multimedia reproducing apparatus from the personal computer.

### DETAILED DESCRIPTION OF THE PRESENT INVENTION

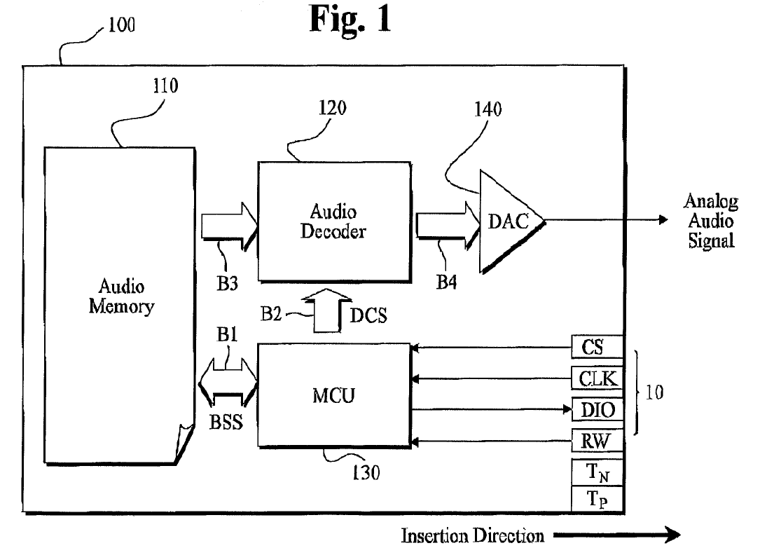

FIG. 1 shows a schematic block diagram of a portable multimedia reproducing apparatus in accordance with a preferred embodiment of the present invention.

As shown in FIG. 1, the portable multimedia reproducing apparatus 100, which is similar to a credit-card, comprises an audio memory 110 in which digital audio data compressed by, e.g. MP3 format, has been previously stored, an MP3-based audio decoder 120 for decoding the digital audio data outputted from the audio memory 110, a digital to analog convener (DAC) 140 for converting the decoded digital data by the audio decodes 120 to a standard analog signal, and a micro-controller unit (MCU) 130 for controlling the operation of the audio memory 110 the audio decoder 120 and the DAC 140. In FIG. 1, terms BSS and DCS represent a block specifying signal and a decode control signal respectively, which will be described later in more detail.

It should be mentioned that, even though the audio decoder 120 is based on the MP3 format, it is not limited thereto. It may be varied according to a compression scheme, e.g. WMV, AAC, Bytero, for the audio data stored in the audio memory 110.

The data communication portion 10 uscs. for example, a synchronous serial communication scheme for 8-bit data transmission in order to reduce the number of signal lines between the portable multimedia reproducing apparatus 100 and external devices.

The audio memory 110 is made of a Mask ROM, EEPROM, EPROM, or OTP (one-time programmable) ROM which is integrated with the portable multimedia reproducing apparatus 100. Digital audio data is pre-stored in the audio memory 110 by a record provider or copyright holders.

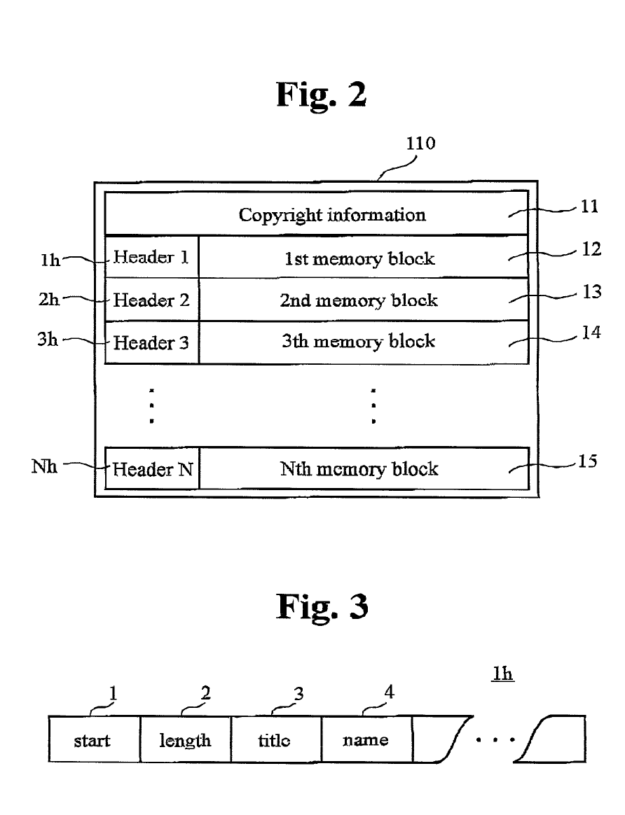

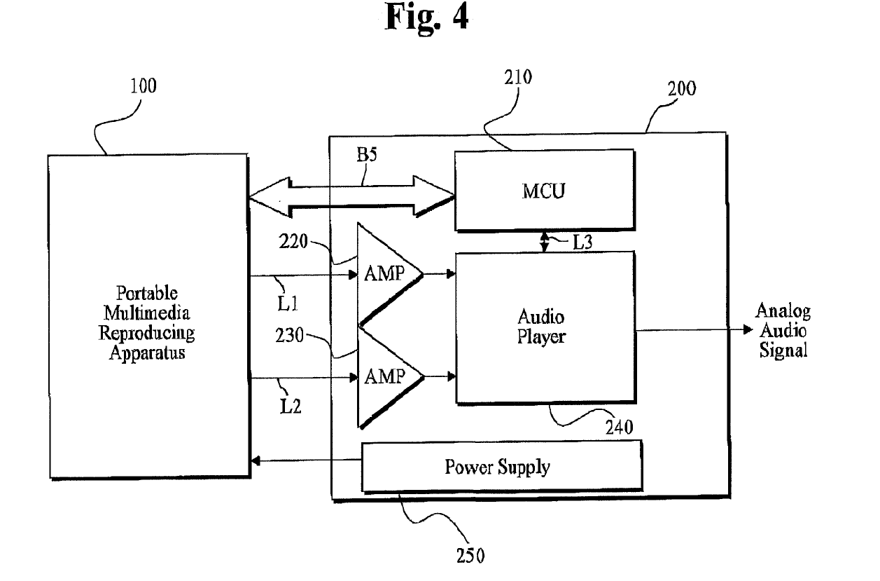

FIG. 2 schematically shows an internal configuration of the audio memory 110 shown in FIG. 1. The audio memory 110 comprises a plurality of memory blocks 12 to 15 each of which stores a piece of music and includes a header. The volume of the audio memory 110 may be varied within the limits that it can be built in the portable multimedia reproducing apparatus 100. Further, as shown in FIG. 2, the audio memory 110 stores copyright information 11, which represents the holder of the copyright of the stored audio data, a company logo of The record provider, the total number of songs and the like. As shown in FIG. 3, each of the )leader information 1h to Nh corresponding to each of the plurality of the memory blocks 12 to 15 includes information such as a music start position 1, music length 2, music Title 3, singer 4 corresponding to audio data of one music stored in each memory block.

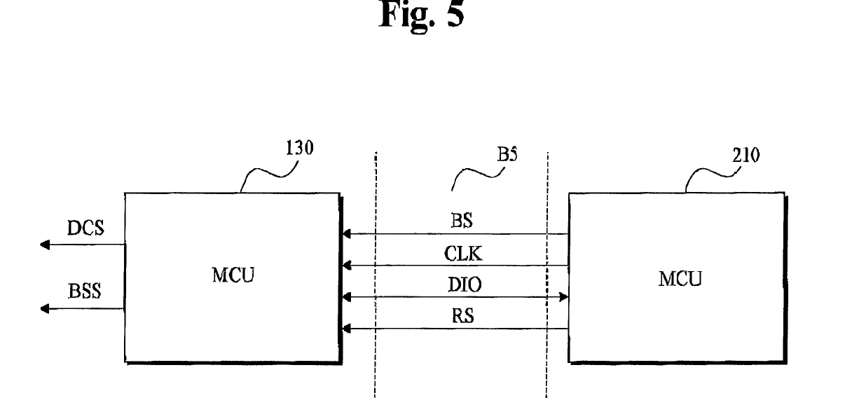

FIG. 4 represents a schematic block diagram illustrating a data processing procedure where the portable multimedia reproducing apparatus 100 is inserted into an external audio system 200. FIG. 5 illustrates data communications between the MCU 130 of the portable multimedia reproducing apparatus 100 and an MCU 210 of the external audio system 200 through tie data communication portion 10 shown in FIG. 1.

The following is a detailed description on the operation of the portable multimedia reproducing apparatus 100 in accordance with the present invention and reference to FIGS. 1 to 5.

When the portable multimedia reproducing apparatus 100 of the present invention is inserted into the external audio system 200 in the direction of the arrow in FIG. 1, power is applied from a power supply 250 of the external audio system 200 to the portable multimedia reproducing apparatus 100 through two power terminals T_{P} and T_{N} provided at the insertion side. Upon the application of power, tho MCU 130 of the portable multimedia reproducing apparatus 100 retrieves the copyright information 11 stored in the audio memory 110 and the header information of each of the memory blocks 12 to 15, and transmits them to the MCU 210 of the external audio system 200 through a terminal DIO of the data communication portion 10. Next, when the user of the external audio system 200 selects a desired song or music based on the header information, the MCU 210 transmits a block selection signal BS specifying a memory block where the selected music is stored, and a read, signal WR, together with a synchronous signal CLK to the MCU 130 of the portable multimedia reproducing apparatus 100 via a bus B5.

In response to the block selection signal BS, the MCU 130 outputs a signal BSS designating the specified memory block to the audio memory 110 via a bus B1. Simultaneously, it generates a decoder control signal DCS to the audio decoder 120 via a bus B2.

The audio decoder 120, responsive to the doctor control signal DCS, retrieves and decodes audio data corresponding to the block specifying signal BSS among the memory blocks 12 to 15 in the audio memory 110, and provides the decoded audio data to the DAC 140 via a bus B4.

The DAC 140 converts the decoded audio data inputted thereto into a predetermined channel of analog audio signals and directs them to the external audio system 200, wherein the predetermined channel is two.

In accordance with the present invention, the portable multimedia reproducing apparatus 100 controls the audio decoder 120 to allow it to selectively or continuously decode the digital audio data pre-stored in the audio memory 110.

Referring to FIG. 4, the external audio system 200 receives the two channels of the audio signals outputted from the DAC 140 via lines L1 and L2 at its fist and second amplifiers (AMPs) 220 and 230. The AMPs 220 and 230 amplify the audio signals and forwards the amplified audio signal to an audio player 240, which reproduces the amplified audio signals using an acoustic device (not shown) under the control of the MCU 210. The user is directly capable of listening to the analog audio signal outputted from the portable multimedia reproducing apparatus 100 through an acoustic device such as an earphone.

Even though the output of the audio signals from the portable multimedia reproducing apparatus 100 is described as the two channels in FIG. 4, it should be noted that three or more channels of audio signal might be extended depending on the specification of an audio system.

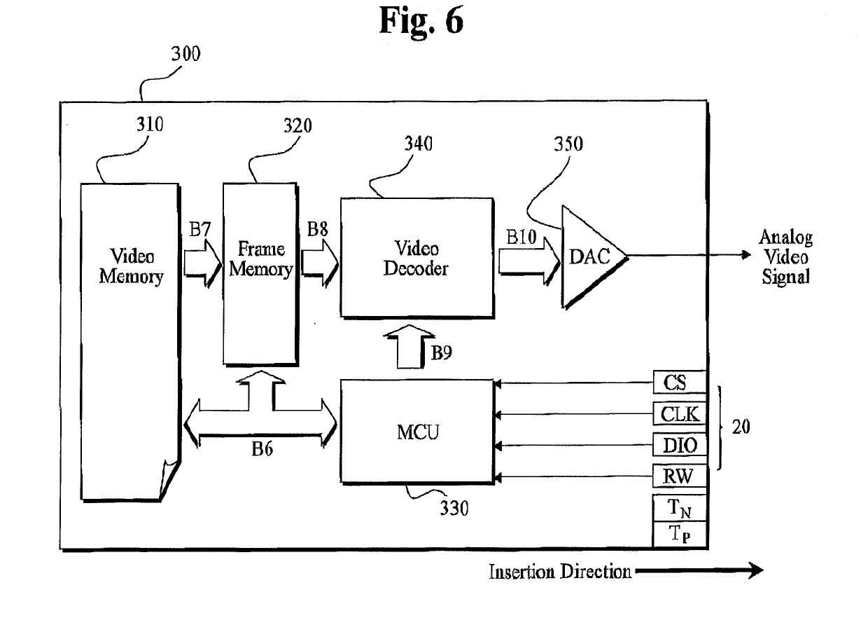

FIG. 6 is a schematic block diagram of a portable multimedia reproducing apparatus 300 showing another embodiment of the present invention. The portable multimedia reproducing apparatus 300 is similar to the portable multimedia reproducing apparatus 100 previously described with reference to FIG. 1, except that it is provided with a video memory 310, a frame memory 320 and a video decoder 340, and therefore different elements will be mainly described.

As shown in FIG. 6, the portable multimedia reproducing apparatus 300 of a card type comprises the video memory 310 for previously storing therein MPEG-4 moving picture data or video data such as a music video; the frame memory 320 for extracting the video data stored in the video memory 310 on a frame-by-frame basis via a bus B7 and temporarily storing it therein; the MPEG4-based video decoder 340 for decoding the video data outputted from the frame memory 320 via a bus B8, a DAC 350 for converting the decoded video data by the video decoder 340 into a standard analog video signal; and an MCU 330 for controlling the video memory 310, the frame memory 320, the video decoder 340 and the DAC 350.

In accordance with the present invention, the video memory 310 is made of a Mask ROM, EEPROM, EPROM, or OTP (one-time programmable) ROM, which, is integrated with the portable multimedia reproducing apparatus 300. Digital video data is previously stored in the video memory 310 by a record provider or copyright holders. Further, although the video decoder 340 is based on the MPEG4 compression scheme, it is Dot limited to this example. Variations will be apparent to those skilled in the art after having the benefit of this disclosure such as according to compression schemes for the video data stored in the video memory 310.

The present invention outputs the final signal to be outputted from the portable multimedia reproducing apparatus 300 as the standard video signals, which is compatible with typical image reproducing devices such as video cassette recorders and televisions, without using a separate external player, thereby making it possible to suppress the original video data previously stored in The video memory 310 from being copied by an unauthorized (non-copyright licensed) person.

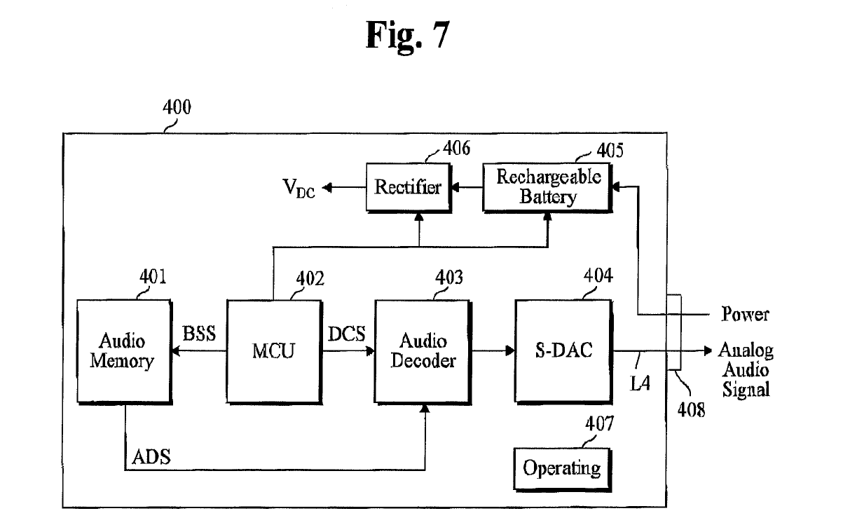

FIG. 7 is a schematic block diagram of a portable multimedia reproducing apparatus 400 in accordance with another preferred embodiment of the present invention. The portable multimedia reproducing apparatus 400 is similar to that of each embodiment previously described, except that it is provided with a rechargeable battery 405, a rectifier 406 coupled with the rechargeable battery 405 and an operating portion 407, and therefore different elements will be mainly described.

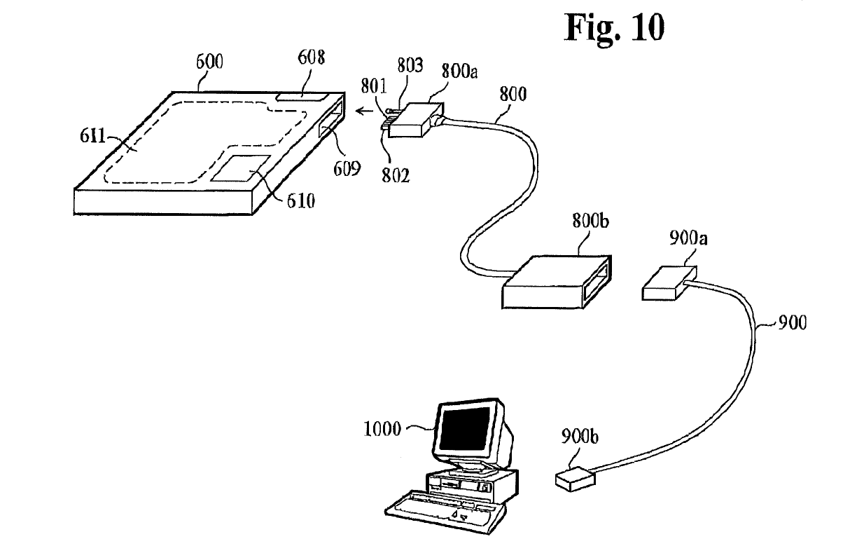

In the portable multimedia reproducing apparatus 400, the rechargeable battery 405, which generates a predetermined voltage needed to drive each element in the apparatus, is charged with a power applied thereto through an external interface, which will be described later in more detail. The rectifier 406 rectifies the power outputted from the rechargeable battery 405 and generates a driving voltage V_{DC} to be applied to each element in the apparatus. The operating portion 407 includes a plurality of buttons, and a display on which displayed are a list of the digital audio data stored in the audio memory 401, selected track information, volume, remaining amount information and the like according to operations of the user. For example a liquid crystal display (LCD) is used as the display, which will be described later in more detail in reference to FIG. 10.

As shown in FIG. 7, the portable multimedia reproducing apparatus 400 of the present invention incorporates therein the audio memory 401 as a package, and outputs the final signal to be outputted therefrom as the standard video signals, which is compatible with typical image reproducing devices such as a video cassette recorder and television, thereby making it possible to suppress the original video data previously stored in the memory from being copied by an unauthorized person.

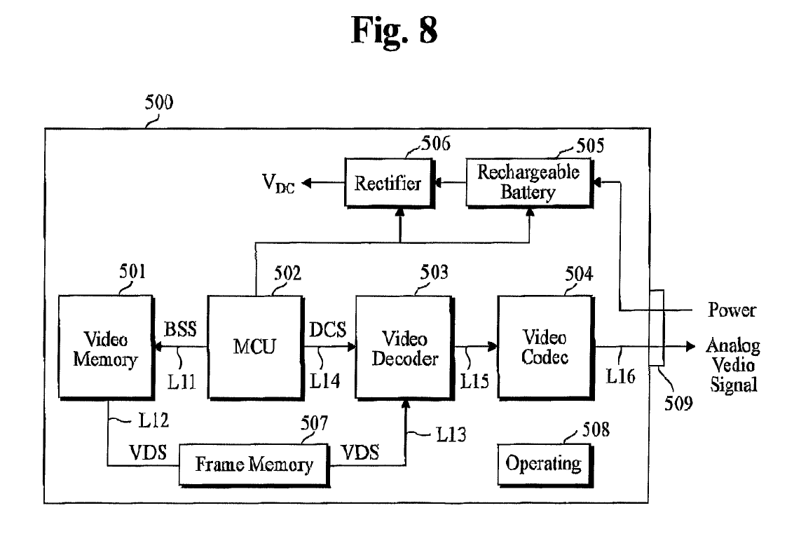

FIG. 8 is a schematic block diagram of a portable multimedia reproducing apparatus 500 in accordance with another preferred embodiment of the present invention The portable multimedia reproducing apparatus 500 is similar to that of the embodiment shown in FIG. 7, except that it is provided with a video memory 501, a video decoder 503 a video codec 504 and a frame memory 507, and therefore different elements will be mainly described.

In the portable multimedia reproducing apparatus 500 shown in FIG. 8, the video memory 501 previously stores MPEG-4 moving picture data or video data such as a music video, and may be configured of a Mask ROM, EEPROM, EPROM, or OTP (one-time programmable) ROM, which is integrated with the portable multimedia reproducing apparatus 300- Further, digital video data is previously stored in the video memory 501 by a record provider or copyright holders.

The frame memory 507 temporally stores therein a video data stream VDS outputted via a line L12 from the video memory 501 on a frame-by-frame basis under the control of the MCU 502, and provides them to the video decoder 503 The video decoder 503 is based on, e.g., MPEG4 compression, decodes the video data stream VDS inputted thereto via a line L13 from the frame memory 507 on a frame-by-frame responsive to the control signal DCS from the MCU 502 via a line L14, and provides it to the video codec 504. In the video codec 504, the decoded digital data is converted into a standard analog video signal, which is outputted via a line L16. Although the video decoder 503 is exemplified as being based on the MPEG4 compression, variations will become apparent to those skilled in the art after having the benefit of this disclosure such as according to compression schemes for the video data stored in the video memory 501.

As shown in FIG. 8, the portable multimedia reproducing apparatus 500 converts the digital multimedia data pre-stored in the video memory 501, which is incorporated in the apparatus as a package, into the standard video signals, which is compatible with typical image reproducing devices such as video cassette recorders and televisions, and Outputs it on the devices, thereby making it possible to suppress the original video data previously stored in the video memory from being copied by an unauthorized person.

For convenience sake, the portable multimedia reproducing apparatuses 400 and 500 shown in FIGS. 7 and 8 may include a remote controller (not shown) as a peripheral. The remote controller may also comprise a display (not shown), which is capable of displaying audio or video information stored in the audio or video memory thereon.

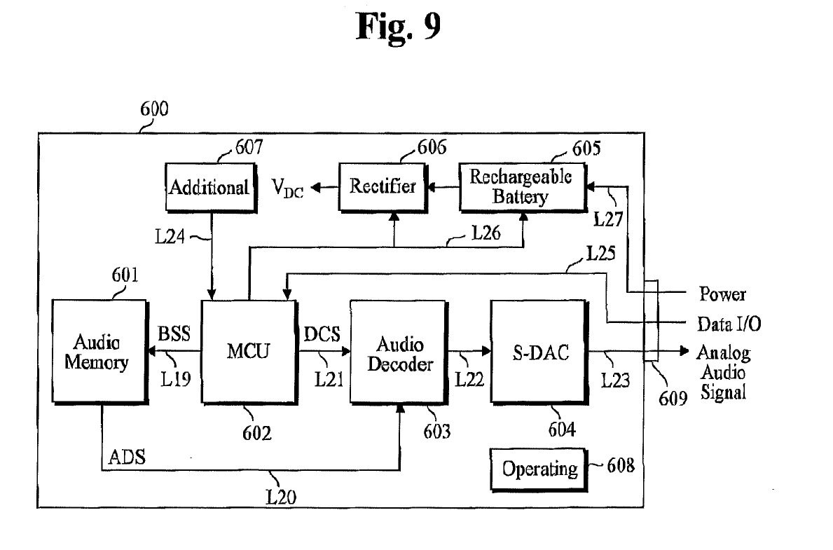

FIG. 9 is a schematic block diagram of a portable multimedia reproducing apparatus 600 in accordance with still another preferred embodiment of the present invention. FIG. 10 is a diagram of illustrating that the portable multimedia reproducing apparatus 600 in FIG. 9 downloads digital multimedia data on communication networks using external interfaces and a personal computer.

Referring again to FIG. 9, registered in the additional memory 607 are an identification code which is uniquely assigned to the portable multimedia reproducing apparatus 600, and a protocol for data communications between The personal computer 1000 (see FIG. 10) and an external system. To support this, an input/output terminal 609 is provided on the portable multimedia reproducing apparatus 600. Further, as shown in FIG. 10, a display 610 is provided on the portable multimedia reproducing apparatus 600. A structure of the input/output terminal 609 has the ability to accept therein a terminal 800a as shown in FIG. 10 which will be described below in more detail

As shown in FIG. 10, the portable multimedia reproducing apparatus 600 is coupled with the personal computer 1000 through a first and a second interface 800 and 900. The first interface 800 has one terminal 800a of a structure that can be inserted within the input/output terminal 609 of the portable multimedia reproducing apparatus 600, and the other terminal 800b that is coupled with one terminal of the second interface 900. The terminal 800a of the first interface 800 has 9 pins, two of which are power pins 801 to be used in power supply, tree are sound pins 803 to be used in outputting audio signals to an acoustic device such as an earphone, and remaining are data input/output pins 802 to be used for data input/output.

The second interface 900, which has typical USB (Universal Serial Bus) ports 900a and 900b at both ends, is connected with an USB port (not shown) in the personal computer 1000. As such, a central processing unit (not shown) of the personal computer 1000 identifies the presence of the portable multimedia reproducing apparatus 600, thereby making it possible to control the portable multimedia reproducing apparatus 600. Thus, the present invention provides a control screen 200 to allow a user to control the portable multimedia reproducing apparatus 600 on a monitor of the personal computer 1000.

By the control screen 200, the portable multimedia reproducing apparatus 600 of the present invention has the ability to download data from the personal computer 1000, thereby downloading various digital multimedia data from a web server via a communication network such as the Internet.

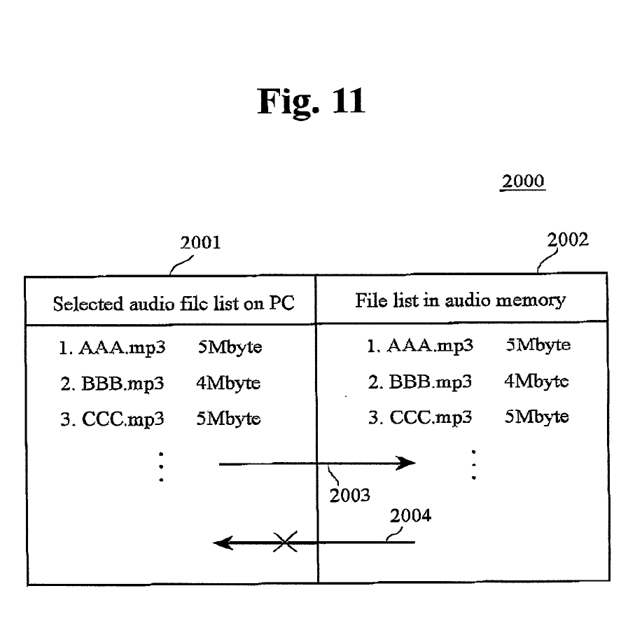

For example, when the user wants to download a desired audio file from a web server using the personal computer 1000, she connects the portable multimedia reproducing apparatus 600 to The personal computer 1000 using the first and second interfaces 800 and 900, and log into the web serve by a typical procedure. Thereafter, if the user selects a desired audio file among the various digital multimedia data provided from the web server, as shown in a PC audio file selection list 2001 in FIG. 11, an identification code registered in the additional memory 607 in the portable multimedia reproducing apparatus 600 is sent to the web server, which performs a typical authentication procedure on the portable multimedia reproducing apparatus 600 based on the identification code sent thereto- Upon completion of the procedure, as shown in a file list in audio memory 2002 in FIG. 11, the selected digital multimedia data is downloaded to the audio memory 601 in the portable multimedia reproducing apparatus 600 trough the personal computer 1000. The other terminal 800b of the first interface 800 functions as a data buffer.

Thus, the present invention, based on the identification code uniquely assigned to the portable multimedia reproducing apparatus. performs the typical authentication procedure, and allows for download of the digital multimedia data from the web server, resulting in enhancement of copyright protection.

Furthermore, each audio file information listed on tho file list in audio memory 2002 comprises a music title, singer. size, etc., excluding an actual sound source so that the user obtains only schematic information of the audio file stored in the audio memory. Thus, in contrast to the typical MP3 player, the present invention has the ability to restrict upload of the audio file stored in the audio memory to a memory of the personal computer. Therefore, the present invention prevents the audio files stored in the portable multimedia reproducing, apparatus from being spread over onto other players, resulting in enhancement of copyright protection.

Further, in the present invention, the rechargeable battery of the portable multimedia reproducing apparatus is charged with a power supply provided from the personal computer through the power pins of the input/output terminal, the first and second interfaces, thereby eliminating a need to prepare separate power adapters.

Moreover, the configuration of the interfaces allows the portable multimedia reproducing apparatus to download digital data including an image, text from peripheral devices including a scanner, printer and the like, and to display the downloaded data on another external display(s) as noted above.

Likewise, the portable multimedia reproducing apparatus of the present invention has a card shape of plat surface 611, thereby allowing the user to freely change the design of the plat surface 611 to suit the user's taste or aesthetic variation.

The present invention outputs the final signal to be outputted from the portable multimedia reproducing apparatus as the standard video signals, which is compatible with typical image reproducing devices such as video cassette recorders and televisions, without using a separate external player, thereby making it possible to suppress the original video data previously stored in the video memory from bring copied by an unauthorized person.

While the present invention has been described and illustrated with respect to a preferred embodiments of the invention, it will be apparent to those skilled in the art that variations and modifications are possible without deviating from the broad principles, spirit and teachings of the present disclosure.

What is claimed is:

1. A portable apparatus for reproducing compressed digital multimedia data, which comprises;
an input/output terminal;
a memory in which the compressed digital multimedia data is previously stored;
an operating portion having a plurality of buttons,
a decoding means for decoding the compressed digital multimedia data;
a converting means for converting the decoded digital multimedia data by the decoding means into a standard analog signal and outputting it through the input/output terminal; and
a controlling means for controlling the memory, the decoding means and the converting means, responsive to an instruction from the operating portion by a user, and
a power supply for supplying a driving voltage to each of the memory, the decoding means and the converting means.

2. The apparatus of claim 1, wherein the apparatus is in the shape of a card.

3. The apparatus of claim 1, wherein the power supply is a built-in battery.

4. The apparatus of claim 3, wherein the built-in battery is charged with a power supply provided thereto from an external device, when the apparatus is connected with the external devise.

5. The apparatus of claim 4, wherein the compressed digital multimedia data stored in the memory is accessed by the external device.

6. The apparatus of claim 5, wherein the memory is selected from the group consisting of a Mask ROM (read only memory), EEPROM, EPROM and OTP (one-time programmable) ROM.

7. The apparatus of claim 6, wherein the memory is integral with the portable multimedia reproducing apparatus.

8. The apparatus of claim 1, further comprising a displaying means for displaying information relating to the digital multimedia data stored in the memory.

9. The apparatus of claim 1, further comprising a frame memory for storing video data on a frame-by-frame basis, when the digital multimedia data stored in the memory is the video data.

10. A portable apparatus for reproducing compressed digital multimedia data, which comprises.
an input/output terminal;
a memory in which the compressed digital multimedia data is previously stored;
an operating portion having a plurality of buttons;
a decoding means for decoding the compressed digital multimedia data,
a converting means for converting the decoded digital multimedia data by the decoding means to a standard analog signal and outputting it through the input/output terminal;
a controlling means for controlling the memory, the decoding moans and the converting Means, responsive to an instruction from the operating portion by a user;
a power supply for supply a driving voltage to each of the memory, the decoding means and the converting means; and
an interface connected wit the input/output terminal, for connecting the reproducing apparatus to a personal computer.

11. The apparatus of claim 10, wherein the apparatus is in the, shape of a flat card.

12. The apparatus of claim 10, wherein the power supply is a built-in battery.

13. The apparatus of claim 12, wherein the built-in battery is charged with a power supply provided from the personal computer, when the system is connected with the personal computer.

14. The apparatus of claim 10, wherein the memory is selected from the group consisting of a Mask ROM (read only memory), EEPROM, EPROM and OTP (one-time programmable) ROM.

15. The apparatus of claim 14, wherein the memory stores an identification code, which is uniquely assigned to the apparatus.

16. The apparatus of claim 10, further comprising a displaying means for displaying information relating to the digital multimedia data stored in the memory.

17. The apparatus of claim 13, wherein the interface includes a first and a second interface, wherein the first interface has a first terminal of a structure which is matched with the input/output terminal and a second terminal which is coupled with a primary terminal of the second interface, wherein the first terminal of the first interface has 9 pins, two of which are power pins to be used in power supply, three are sound pins to be used in outputting signals to an external device, and remaining are data input/output pins to be used for data input/output; and
wherein the second interface has USB (Universal Serial Bus) ports at both ends, one of which is connected with the second terminal of the first interface, and the other is connected with an USB port in the personal computer.

18. The apparatus of claim 10, wherein digital multimedia data on a web server is downloaded to the memory through a communication network, the personal computer, and the first and second interfaces.

19. The apparatus of claim I 8, wherein the identification code is transmitted to the web server through the communication networks during the download.

20. The apparatus of claim 19, wherein of the digital multimedia data stored in the memory, only data excluding an actual sound source is read out by the personal computer.
